(19) United States
(12) Patent Application Publication
(10) Pub. No.: US 2017/0286181 A1
(43) Pub. Date: Oct. 5, 2017

(54) DEPLOYMENT AND EXECUTION OF SENSING AND COMPUTATIONAL TASKS IN A NETWORK OF COMPUTING DEVICES

(71) Applicant: INTERNATIONAL BUSINESS MACHINES CORPORATION, Armonk, NY (US)

(72) Inventors: SHAHROKH DAIJAVAD, MORGAN HILL, CA (US); NIRMIT V. DESAI, YORKTOWN HEIGHTS, NY (US); SONGCHUN FAN, DURHAM, NC (US); MARTIN G. KIENZLE, OSSINING, NY (US); THEODOROS SALONIDIS, BOSTON, MA (US); RAHUL URGAONKAR, SHORELINE, WA (US); DINESH C. VERMA, NEW CASTLE, NY (US)

(21) Appl. No.: 15/088,466

(22) Filed: Apr. 1, 2016

(51) Int. Cl. G06F 9/50

(52) U.S. Cl. CPC G06F 9/5088; G06F 9/5044

(57) ABSTRACT

Embodiments include methods, systems and computer programs for deployment and execution of tasks in a network of computing devices. Aspects include creating by a requester device of a task for deployment and execution in the network wherein the task is composed of a set of computing and sensing programs and a task representation that includes at least one of computing requirements, data requirements, and context requirements and transmitting the task representation to at least one member of the network of computing devices. Aspects also include selecting a plurality of computing devices in the network that match at least one of the computing requirements, the data requirements, and the context requirements in the task representation and deploying each of the set of computing and sensing programs of the task to the selected computing devices.

### BACKGROUND

The present disclosure relates to methods, systems, and computer program products for deployment and execution of sensing and computation tasks in a network of computing devices.

Device-computing networks are networks of computing devices, such as smartphones, laptops, tablets, sensors, or devices deployed at the network edge such as Wi-Fi Access Points, Home Gateways or cellular base stations, etc., that are in communication with one another through wireless and/or wired network links. Recently, users of computing devices have begun to rely on their devices to perform more powerful and computationally intensive operations, which may exceed the capabilities of a single computing device. Thus, it is necessary to devise methods and systems to efficiently deploy and collaboratively execute tasks in networks of computing devices.

In traditional computing environments such as computing clusters or data centers, computing tasks are often distributed across multiple computing server machines which have high computing capabilities and are connected with high bandwidth wired links. Typically, the decision of how to deploy and execute tasks depends on the computing or network characteristics of the computing cluster.

However, the deployment of sensing and computing tasks among computing devices in a computing network poses several unique challenges. In contrast to server machines in a data center, the devices are typically mobile or portable, have a relatively smaller physical footprint and processing capabilities, they are equipped with sensors, and are deployed in the physical world. Therefore, a deployed task in such a device-computing network involves sensing in addition to computation and its deployment depends not only on computing and network requirements but also on the device data and the device context created by the device interactions with the physical world.

In addition, task deployment in networks of computing devices requires discovery of the devices that can execute the task. In general, automatic detection of devices and services offered by computing devices in a computer network is performed by service discovery protocols. Service discovery protocols for different types of networked systems, including systems with wireless devices, are available. However, existing service discovery protocols are focused on discovering existing services that are already deployed in the network devices. They do not support the discovery of devices for tasks that have not yet been deployed. In addition, existing service discovery protocols do not enable execution of different parts of a service at different devices and do not support collaborative computations.

### SUMMARY

In accordance with an embodiment, a method for deployment and execution of sensing and computation tasks in a network of computing devices. The method includes creating by a requester device of a task for deployment and execution in the network wherein the task is composed of a set of computing and sensing programs and a task representation that includes, at least, one of computing requirements, data requirements, and context requirements and transmitting the task representation to at least one member of the network of computing devices. The method also includes selecting a plurality of computing devices in the network that match at least one of the computing requirements, the data requirements, and the context requirements in the task representation and deploying each of the set of computing and sensing programs of the task to the selected computing devices.

In accordance with another embodiment, a network of computing devices for deployment and execution of sensing and computation tasks includes a computing device having a processor in communication with one or more types of memory. The processor is configured to create by a requester device of a task for deployment and execution in the network wherein the task is composed of a set of computing and sensing programs and a task representation that includes, at least, one of computing requirements, data requirements, and context requirements and to transmit the task representation to at least one member of the network of computing devices. The processor is also configured to select a plurality of computing devices in the network that match at least one of the computing requirements, the data requirements, and the context requirements in the task representation and deploy each of the set of computing and sensing programs of the task to the selected computing devices.

In accordance with a further embodiment, a computer program product for deployment and execution of computation tasks in a network of computing devices includes a non-transitory storage medium readable by a processing circuit and storing instructions for execution by the processing circuit for performing a method. The method includes creating by a requester device of a task for deployment and execution in the network wherein the task is composed of a set of computing and sensing programs and a task representation that includes, at least, one of computing requirements, data requirements, and context requirements and transmitting the task representation to at least one member of the network of computing devices. The method also includes selecting a plurality of computing devices in the network that match at least one of the computing requirements, the data requirements, and the context requirements in the task representation and deploying each of the set of computing and sensing programs of the task to the selected computing devices.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating one example of a processing system for practice of the teachings herein;

FIG. 2 is a block diagram illustrating a device-computing network in accordance with an exemplary embodiment;

FIG. 3 is a flow diagram of a method for deployment of computation tasks in a device-computing network in accordance with an exemplary embodiment;

FIG. 4 is a flow diagram of a method for execution of computation tasks in a device-computing network in accordance with an exemplary embodiment; and

FIG. 5 is a flow diagram of a method for deployment and execution of computation tasks in a device-computing network in accordance with an exemplary embodiment.

### DETAILED DESCRIPTION

In exemplary embodiments, methods, systems, and computer program products for deployment and execution of computation tasks in a device-computing network are provided. In general, a device-computing network is comprised of computing devices, smartphones, laptops, tablets, sensors, or devices deployed at the network edge such as Wi-Fi Access Points, Home Gateways or cellular base stations, etc., that are in communication with one another through wireless and/or wired network links. These computing devices may be heterogeneous and each device may include a wide range of characteristics, such as processing capability, available sensors, data storage capabilities, network bandwidth, available power, and the like. In addition, the members of the device-computing network are dynamic, in that they change over time as devices join and leave the device network. In exemplary embodiments, the device-computing network is an ad hoc network and the computing devices are mobile computing devices.

In exemplary embodiments, the device-computing network is comprised of a plurality of computing devices that are configured to perform sensing and computational tasks. The computing devices are interconnected through a network using one or more different wireless network interfaces, such as WLAN, Wi-Fi, cellular, etc. In exemplary embodiments, a requestor device is a member of the device-computing network that creates or receives a task to be executed by the device-computing network. The requestor device is configured to decompose, or divide, the task into a plurality of sub-tasks, which are then transmitted to the other members of the device-computing network for execution.

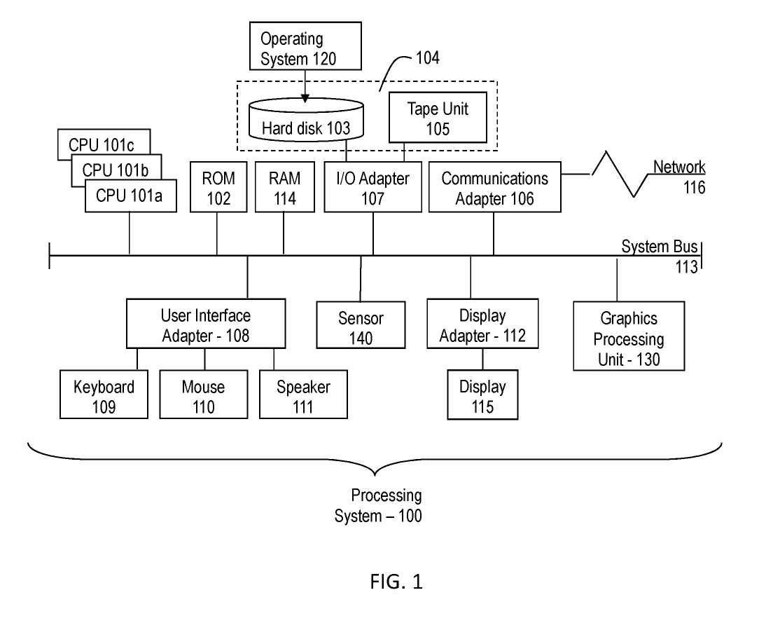

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 1, the system 100 includes processing capability in the form of processors 101, storage capability including the system memory 114 and mass storage 104, input means such as keyboard 109 and mouse 110, and output capability including speaker 111 and display 115. In one embodiment, a portion of system memory 114 and mass storage 104 collectively store an operating system to coordinate the functions of the various components shown in FIG. 1.

In exemplary embodiments, the system 100 includes one or more sensors 140. In exemplary embodiments, the sensors 140 can include any of a wide variety of known sensors, which can include, but are not limited to, temperature sensors, location sensors, occupancy sensors, optical sensors, odor sensors and the like.

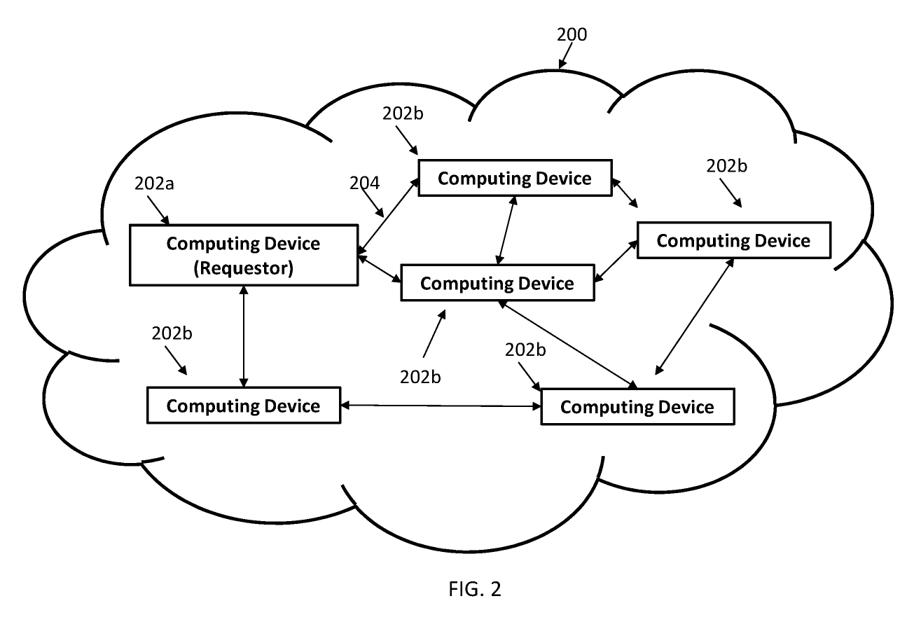

Referring now to FIG. 2, a device-computing network 200 in accordance with an exemplary embodiment is illustrated. As illustrated, the device-computing network 200 includes a plurality of computing devices 202. The computing devices 202 are interconnected via one or more wireless communications links 204. Although the communications links 204 are shown as point-to-point links, the communications links 204 may not be point-to-point. In other words, two computing devices 202 that are connected to the same Wi-Fi network, or the like, are also considered to be in wireless communication with one another. In exemplary embodiments, one or more of the computing devices 202 may be a requestor device 202a, which decomposes a task for completion and transmits a representation of the task which includes its decomposition in sub-tasks to one or more worker devices 202b. In response, the worker devices 202b will select which sub-tasks they can execute and transmit an indication of those sub-tasks back to the requestor device 202a.

Although not shown, one of the computing devices 202 may be configured to act as a coordinator that coordinates the execution of the sub-tasks by the worker devices 202b. In exemplary embodiments, the requestor device 202a may be configured to act as the coordinator, or one of the worker devices 202b may be configured to act as the coordinator. In one embodiment, a worker device 202b may be selected to act as the coordinator based on a characteristic of the worker device 202b. For example, the worker device 202b, that is either most powerful, or has most remaining energy, or it has highest quality network connections to the other devices, or has been a member of the device-computing network 200 the longest, or some optimal combination of the above, may be designated as a coordinator.

In one embodiment, a decomposed task representation transmitted to a computing device 202 may include a code to be executed by the computing devices 202. In another embodiment, a decomposed task representation transmitted to a computing device 202 may include a link to a network location at which the code to be executed by the computing devices 202 is stored. In a further embodiment, the decomposed task representation transmitted to a computing device 202 may include an identification of code to be executed that is stored on the computing 202. The decomposed task representation includes various sub-tasks of the task.

In exemplary embodiments, the sub-task may include a destination for the computing devices 202 to transmit the data resulting from the execution of the sub-task. Based on the sub-task, the destination may be the requestor device 202a or it may be another worker device 202b. For example, a requestor device 202a may have a task that is decomposed into a sensing sub-task that is performed by a first worker device 202b and a computational sub-task performed by a second worker device 202b, which relies on the data from the sensing task. In this example, the first worker device 202b can be configured to transmit the sensed data directly to the second worker device 202b. Alternatively, the first worker device 202b can be configured to transmit the sensed data to another network location that is accessible by the second worker device 202b.

In exemplary embodiments, the device-computing network 200 is configured to connect a requesting device 202a to a network of heterogeneous worker devices that provide sensing and computation services. The requesting device 202a includes one or more sensing and computational tasks which must be deployed and executed on the network by the worker devices 202b. The worker devices are characterized by their computing capabilities, their data (sensed or stored) and their context. In exemplary embodiments, the worker devices 202b may act as sensing data sources, data processors and data routers. The worker devices 202b may also have heterogeneous processing, storage, and sensing capabilities. Some of the worker devices 202b may only perform specialized sensing and processing operations and others can perform general sensing and processing operations. In some embodiments, worker devices 202b support downloading of software modules that enable them to perform sensing and computation operations. Downloading can be performed either by a software repository or through other devices.

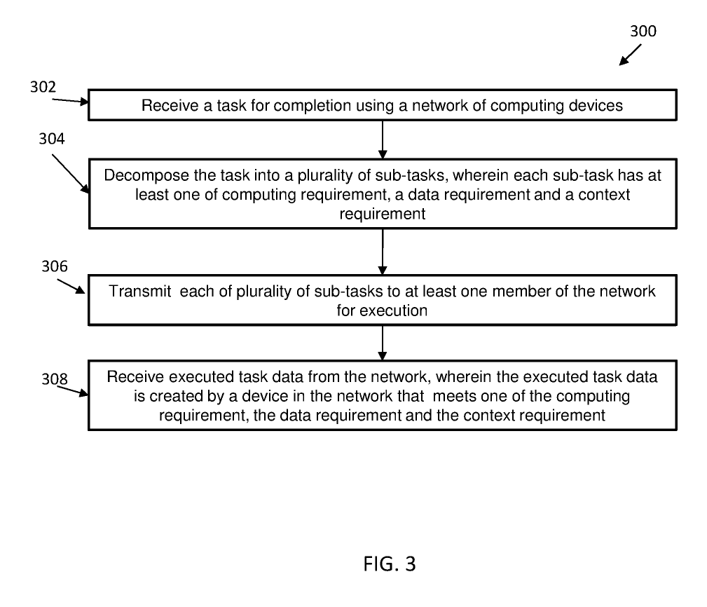

Referring now to FIG. 3, a flow diagram of a method 300 for deployment of computation tasks in a device-computing network in accordance with an exemplary embodiment is shown. As shown at block 302, the method 300 includes receiving a task for completion using a device-computing network. In exemplary embodiments, the task is received by a first computing device, which is part of the device-computing network. Next, as shown at block 304, the method 300 includes decomposing the task into a plurality of sub-tasks, wherein each sub-task has, at least, one of computing requirement, a data requirement, and a context requirement. In exemplary embodiments, the task is decomposed into an application graph of multiple linked subs-tasks and each sub-task including a computing requirement, a data requirement, and a context requirement. For example, a task can be decomposed into sub-tasks that are implemented as functional sensing and/or computation software modules. The sub-tasks are linked with edges that represent the flow of computation and data dependencies between the sub-tasks.

Next, as shown at block 306, the method 300 includes transmitting each of plurality of sub-tasks to at least one member of the device-computing network for execution. In exemplary embodiments, the identification of which computing devices to transmit the sub-task to is determined by transmitting a query message to all computing devices in the device-computing network. In response to this query message, a set of computing devices is selected by matching the sub-tasks with the computing devices based on the characteristics of the computing devices. This selection is performed by the devices matching their compute, data and context characteristics with requirements of the sub-tasks in the received query message and returning the sub-task and send back to the requester device which sub-tasks they can execute, as well as their corresponding characteristics. Based on this information, a decision is made as to which devices will participate in the task and the requester deploys the sub-tasks to the corresponding devices. After deployment of the sub-tasks, the computing devices execute the code corresponding to their sub-tasks and connect together to perform collaborative computations. As shown at block 308, the method 300 also includes receiving executed task data from the device-computing network, wherein the executed task data is created by a mobile device in the device-computing network that meets one of the computing requirement, the data requirement, and the context requirement.

In exemplary embodiments, the computing requirements can include the type of computation performed (e.g. face detection), APIs of software modules, pointers to the physical locations of software modules implementing the sub-task computation (e.g. the requestor device or a trusted code repository), or requirements that need to be met by a device's hardware/software specifications or current processing availability. The computing requirement can also include the location of the software module implementing the sub-task. The sub-task software modules can be co-located with the sub-task representation. The sub-task code the can be either at the requestor device or at a third remote code repository. For example, these requirements can form queries that help discover all computing devices which can perform image processing operations, contain images with faces that have been taken during a certain time interval and are located in a specific area or discover thermal sensors capable of sensing the temperature of a certain room and returning the result in Celsius degrees.

In exemplary embodiments, the data requirements can include a type of data (e.g. video) or format of data (e.g. MP4) that is required by the corresponding sub-task. Context requirements refer to the context where the corresponding sub-task will need to perform the computation on the data (e.g. time, location). The data requirement may refer to a requirement that a computing device possesses a certain type of data or be able to sense that type of data.

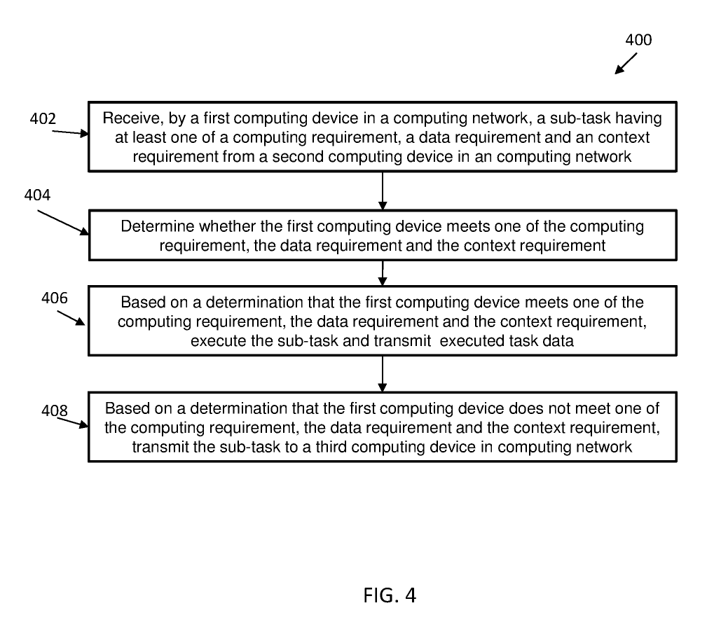

Referring now to FIG. 4, a flow diagram of a method 400 for execution of computation tasks in a device-computing network in accordance with an exemplary embodiment is shown. As shown at block 402, the method 400 includes receiving, by a first computing device in a device-computing network, task representation that includes a sub-task having, at least, one of a computing requirement, a data requirement and a context requirement from a second computing device in a device-computing network. Next, as shown at block 404, the method 400 includes determining whether the first computing device meets one of the computing requirement, the data requirement, and the context requirement. Based on a determination that the first computing device meets one of the computing requirement, the data requirement, and the context requirement, the method 400 includes executing the sub-task and transmitting executed task data, as shown at block 406. Based on a determination that the first computing device does not meet one of the computing requirement, the data requirement, and the context requirement, the method 400 includes transmitting the sub-task to a third computing device in the device-computing network, as shown at block 408. In exemplary embodiments, the task representation that includes the sub-tasks can be forwarded to a third device regardless of whether the sub-tasks can be executed by the first device or not in order to ensure that all the devices see the task representation and perform the matching.

In exemplary embodiments, the matching of computing, data and context requirements between a sub-task and a computing device can be implemented as a query which asks whether a computing device supports a requested type of computation (e.g. running an existing service). If not, the computing device may determine whether it is possible to download the software module of the sub-task which is included in the location computingattribute. The criteria can be based on the trust/security with respect to the specified location, and the current device computation state.

In exemplary embodiments, matching of the computing, data and context requirements between a sub-task and a computing device can be implemented in a distributed fashion or a centralized fashion. In the case of a distributed implementation, the request message is a multicast message sent to the worker devices. Each worker device inspects the task representation and decides which sub-tasks it can execute by matching its compute, data and context state with the compute, data and context requirements of the sub-tasks. Each device returns its decision in a message, which includes its address, the sub-task(s) it can execute and with processing, data and context state. In the case of a centralized implementation, the request message is sent to a server machine that is connected to all the worker devices and acts as coordinator. The coordinator stores the worker device data and context states. In this case, the matching of requirements and state and identification of suitable worker devices is performed on the server machine. The matching depends on the accuracy of the stored state on the server. If the state is fully accurate, the server identifies worker devices by performing matching based on its stored state. If the stored device state is not up to date, the request message is forwarded to the worker devices. If the stored device state is partially accurate, a subset of the devices is first pre-selected based on the message requirements and the accurate part of the stored state, and then the request message is forwarded to the pre-selected devices.

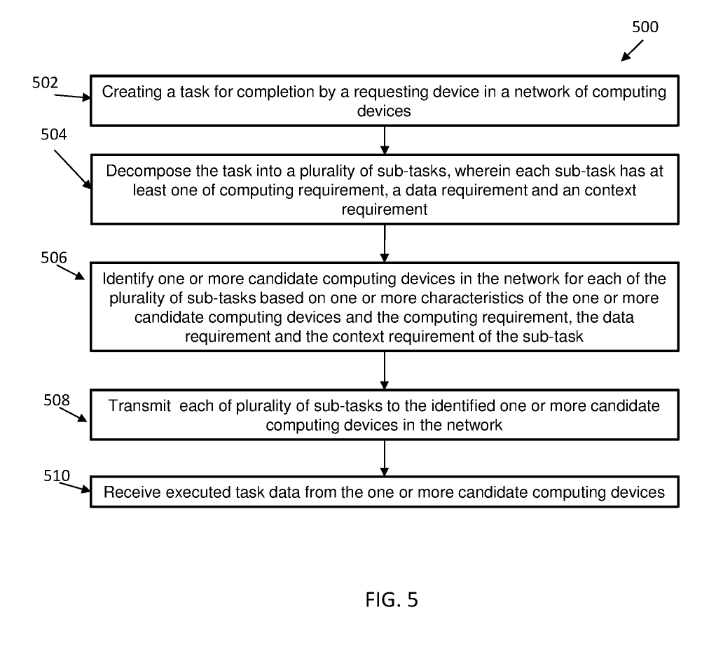

Referring now to FIG. 5, a flow diagram of a method 500 for execution of computation tasks in a device-computing network in accordance with an exemplary embodiment is shown. As shown at block 502, the method 500 includes creating a task for completion by a requesting mobile device in a device-computing network. Next, as shown at block 504, the method 500 includes decomposing the task into a plurality of sub-tasks, wherein each sub-task has, at least, one of computing requirement, a data requirement, and a context requirement. The method 500 also includes identifying one or more candidate computing devices in the device-computing network for each of the plurality of sub-tasks based on one or more characteristics of the one or more candidate computing devices and the computing requirement, the data requirement and the context requirement of the sub-task, as shown at block 506. In exemplary embodiments, a subset of the computing devices is selected that will perform each sub-task is identified.

Next, as shown at block 508, the method 500 includes transmitting each of plurality of sub-tasks to the identified one or more candidate computing devices in the device-computing network. In exemplary embodiments, transmitting each of plurality of sub-tasks to the identified one or more candidate computing devices includes transmitting a notification message is sent to one or more candidate computing devices. The notification message for each device contains the location of the software module of the subtask(s) it will execute and for each such sub-task it contains the addresses of the worker devices that will execute the next sub-task in the task graph. In exemplary embodiments, the one or more candidate computing devices download and install their respective sub-task software modules and establish network connections among each other. The one or more candidate computing devices execute the sensing and computation task in a collaborative fashion and their sensing and computation results are sent to the requestor. Next, as shown at block 510, the method 500 includes receiving executed task data from the one or more candidate computing devices.

In one embodiment, a method for deploying sensing and computation tasks in a device-computing network, containing a requestor device, a sensing and computation task and a plurality of worker includes: creating a decomposed representation of the sensing and computation task that includes a plurality of linked sensing and computation sub-tasks, each sub-task associated with compute, data and context requirements; sending the decomposed representation of the task to the worker devices; determining a set of selected worker devices that can execute instances of the linked sub-tasks, by matching the compute, data and context requirements of sub-tasks with the compute, data and context state of the worker devices; deploying instances of the linked sub-tasks to the selected worker devices; and establishing network connections between the worker devices according to the linkages of their sub-tasks, as defined in the decomposed representation of the sensing and computation task.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method for deployment and execution of tasks in a network of computing devices, the computer implemented method comprises:
creating by a requester device of a task for deployment and execution in the network wherein the task is composed of a set of computing and sensing programs and a task representation that includes at least one of computing requirements, data requirements, and context requirements;
transmitting the task representation to at least one member of the network of computing devices;
selecting a plurality of computing devices in the network that match at least one of the computing requirements, the data requirements, and the context requirements in the task representation; and
deploying each of the set of computing and sensing programs of the task to the selected computing devices.

2. The computer implemented method of claim 1, wherein selecting a plurality of computing devices includes identifying one or more candidate computing devices in the network based on one or more characteristics of the one or more candidate computing devices and the computing requirements, the data requirements, and the context requirements of the task.

3. The computer implemented method of claim 1, wherein the task representation includes a plurality of sub-tasks wherein each of the plurality of sub-tasks includes at least one of the set of computing and sensing programs and at least one of the computing requirements, data requirements, and the context requirements.

4. The computer implemented method of claim 2, wherein at least one of the computing programs is transmitted to two or more candidate computing devices in the computing network.

5. The computer implemented method of claim 2, wherein the one or more characteristics of the one or more candidate computing devices comprises at least one of a processing capacity, a storage capacity, a communication bandwidth capacity, an available power level, one or more available sensors, and a location.

6. The computer implemented method of claim 2, further comprising monitoring a presence of an identified candidate computing device in the network.

7. The computer implemented method of claim 6, further comprising re-transmitting a computing program to another candidate computing device based on a determination that the identified candidate computing device has left the network.

8. The computer implemented method of claim 1, wherein transmitting the task representation to at least one member of the network for execution comprises transmitting a network location of the set of computing programs.

9. The computer implemented method of claim 1, wherein selecting the plurality of computing devices in the computing network that match one of the computing requirement includes negotiating an incentive for execution of the task between the requester device and the matched computing devices.

10. A computer program product for deployment and execution of tasks in a network of computing devices, the computer program product comprising:
a non-transitory storage medium readable by a processing circuit and storing instructions for execution by the processing circuit for performing a method comprising:
creating by a requester device of a task for deployment and execution in the network wherein the task is composed of a set of computing and sensing programs and a task representation that includes at least one of computing requirements, data requirements, and context requirements;
transmitting the task representation to at least one member of the network of computing devices;
selecting a plurality of computing devices in the network that match at least one of the computing requirements, the data requirements, and the context requirements in the task representation; and
deploying each of the set of computing and sensing programs of the task to the selected computing devices.

11. The computer program product of claim 10, wherein selecting a plurality of computing devices includes identifying one or more candidate computing devices in the network based on one or more characteristics of the one or more candidate computing devices and the computing requirements, the data requirements, and the context requirements of the task.

12. The computer program product of claim 10, wherein the task representation includes a plurality of sub-tasks wherein each of the plurality of sub-tasks includes at least one of the set of computing and sensing programs and at least one of the computing requirements, data requirements, and the context requirements.

13. The computer program product of claim 11, wherein at least one of the computing programs is transmitted to two or more candidate computing devices in the computing network.

14. The computer program product of claim 11, wherein the one or more characteristics of the one or more candidate computing devices comprises at least one of a processing capacity, a storage capacity, a communication bandwidth capacity, an available power level, one or more available sensors, and a location.

15. The computer program product of claim 11, wherein the method further comprises monitoring a presence of an identified candidate computing device in the network.

16. The computer program product of claim 15, wherein the method further comprises re-transmitting a computing program to another candidate computing device based on a determination that the identified candidate computing device has left the network.

17. The computer program product of claim 10, wherein transmitting the task representation to at least one member of the network for execution comprises transmitting a network location of the set of computing programs.

18. The computer program product of claim 12, wherein selecting the plurality of computing devices in the computing network that match one of the computing requirement includes negotiating an incentive for execution of the task between the requester device and the matched computing devices.

19. A network of computing devices for deployment and execution of tasks includes a computing device having processor in communication with one or more types of memory, the processor configured to:
create a task for deployment and execution in the network wherein the task is composed of a set of computing and sensing programs and a task representation that includes at least one of computing requirements, data requirements, and context requirements;
transmit the task representation to at least one member of the network of computing devices;
select a plurality of computing devices in the network that match at least one of the computing requirements, the data requirements, and the context requirements in the task representation; and
deploy each of the set of computing and sensing programs of the task to the selected computing devices.

20. The network of claim 19, wherein the task representation includes a plurality of sub-tasks wherein each of the plurality of sub-tasks includes at least one of the set of computing and sensing programs and at least one of the computing requirements, data requirements, and the context requirements.
